(19) United States
(12) Patent Application Publication
(10) Pub. No.: US 2024/0042873 A1
(43) Pub. Date: Feb. 8, 2024

(54) CHARGING GUN FOR CHARGING ELECTRIC VEHICLE

(71) Applicant: PEGATRON CORPORATION, Taipei City (TW)

(72) Inventors: Ying-Hsin LIN, Taipei City (TW); Chun-Sheng CHAO, Taipei City (TW)

(21) Appl. No.: 18/321,518

(22) Filed: May 22, 2023

(30) Foreign Application Priority Data
Aug. 3, 2022 (TW) 111208357

(51) Int. Cl. B60L 53/16; B60L 53/18; H01R 13/639

(52) U.S. Cl. CPC B60L 53/16; B60L 53/18; H01R 13/639; H01R 2201/26

(57) ABSTRACT

A charging gun for charging an electric vehicle including a charging connector and a charging cable is provided. The charging connector has an insertion portion and a turning portion connected to the insertion portion, and an included angle between the insertion portion and the turning portion is greater than or equal to 90 degrees and less than or equal to 100 degrees. The charging cable is connected to the turning portion, and the charging cable includes a plurality of wires arranged in parallel in one direction, to avoid the problem that the charging cable hangs down onto the road and causes danger to passersby.

### CROSS REFERENCE TO RELATED APPLICATIONS

This application claims the priority benefit of Taiwan applications serial no. 111208357, filed on Aug. 3, 2022. The entirety of the above-mentioned patent application is hereby incorporated by reference herein and made a part of this specification.

### BACKGROUND

### Technical Field

The present disclosure relates to a charging gun, and in particular, to a charging gun for charging an electric vehicle.

### Description of Related Art

In response to the trend of international carbon reduction and the wave of electrification, various large car manufacturers have announced plans for the development of electric vehicles. Taiwan has a competitive advantage in the information and communication technology (ICT) industry.

The arrangement of charging piles is always one of the most urgent problems to be resolved during promotion of electric vehicles. Currently, most charging piles are built in a parking lot, and roadside parking zones are not provided with charging piles. With gradual popularization of electric vehicles and the deregulation of laws and regulations, charging piles will be gradually built in the roadside parking zones. However, vehicle manufacturers have no agreement on locations of charging holes for electric vehicles. Some vehicle manufacturers arrange the charging holes at a front of a vehicle, some vehicle manufacturers arrange the charging holes on a right side of a vehicle body, and some vehicle manufacturers arrange the charging holes on a left side of the vehicle body. For a left-drive vehicle, a charging pile built next to the roadside parking zone is usually located on a right side of a vehicle body when the electric vehicle parks at the roadside parking zone. If a charging hole is located at a front or on a left side of the vehicle, a charging connector and a charging cable need to be pulled far away far away from the charging pile, and the charging cable hangs down onto the road, which easily causes danger to passersby.

FIG. 1A is a schematic diagram of an existing charging gun charging an electric vehicle, and FIG. 1B is another schematic diagram of the charging gun in FIG. 1A charging the electric vehicle. As shown in FIG. 1A and FIG. 1B, due to a shape of a charging connector 11, a distance is generated between a charging cable 12 and an electric vehicle 2 when the charging gun 1 is used to charge the vehicle. If the electric vehicle is a left-drive vehicle and a charging hole is arranged on a left side of a vehicle body, the charging cable 12 more easily hangs down onto the road, which easily causes danger to passersby.

### SUMMARY

The disclosure is intended to provide a charging gun for charging an electric vehicle, which can avoid the problem that the charging cable hangs down onto the road and causes danger to passersby.

In order to achieve the above purpose, the disclosure provides a charging gun for charging an electric vehicle, including a charging connector and a charging cable. The charging connector has an insertion portion and a turning portion connected to the insertion portion, and an included angle between the insertion portion and the turning portion is greater than or equal to 90 degrees and less than or equal to 100 degrees. The charging cable is connected to the turning portion, and the charging cable includes a plurality of wires arranged in parallel in one direction.

In an embodiment, the insertion portion is substantially perpendicular to the turning portion.

In an embodiment, the direction is substantially perpendicular to an extending direction of the wires.

In an embodiment, the charging gun further includes at least one light-emitting element arranged on at least a side surface of the charging cable.

In an embodiment, the light-emitting element is arranged at a position other than a side surface of the charging cable facing a body of the electric vehicle.

In an embodiment, the charging gun further includes at least one magnetic element, arranged on a side surface of the charging cable facing the electric vehicle when the charging connector is inserted in the electric vehicle.

Based on the above, in the charging gun of the disclosure, the included angle between the insertion portion and the turning portion of the charging connector is greater than or equal to 90 degrees and less than or equal to 100 degrees, and the charging cable includes the plurality of wires arranged in parallel in the direction. When the charging gun of the disclosure is used to charge the electric vehicle, even if a charging hole is on a left side of the vehicle body, a gap between the charging cable and the vehicle body can be very small, which can avoid an excessively large gap between the charging gun and the vehicle body caused by the appearance design of the existing charging gun, and can avoid the problem that the charging cable hangs down onto the road and causes danger to passersby.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram of an existing charging gun charging an electric vehicle.

FIG. 1B is another schematic diagram of the charging gun in FIG. 1A charging the electric vehicle.

FIG. 2A to FIG. 2C are schematic diagrams of a charging gun according to an embodiment of the present invention at different perspectives.

FIG. 2D is a schematic diagram of the charging gun in FIG. 2C charging an electric vehicle.

FIG. 3 and FIG. 4A are schematic diagrams of charging guns according to different embodiments of the present invention.

FIG. 4B is a schematic diagram of the charging gun in FIG. 4A charging an electric vehicle.

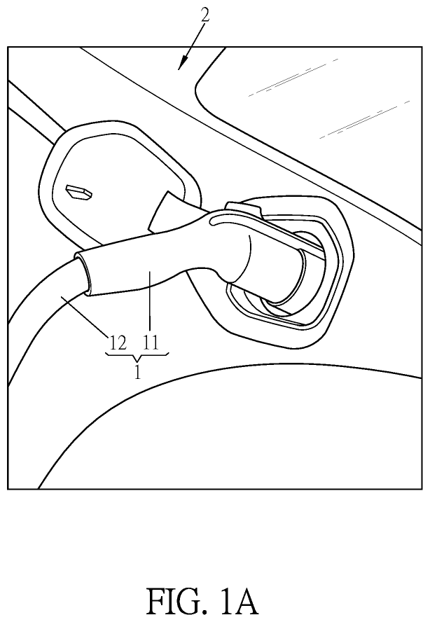

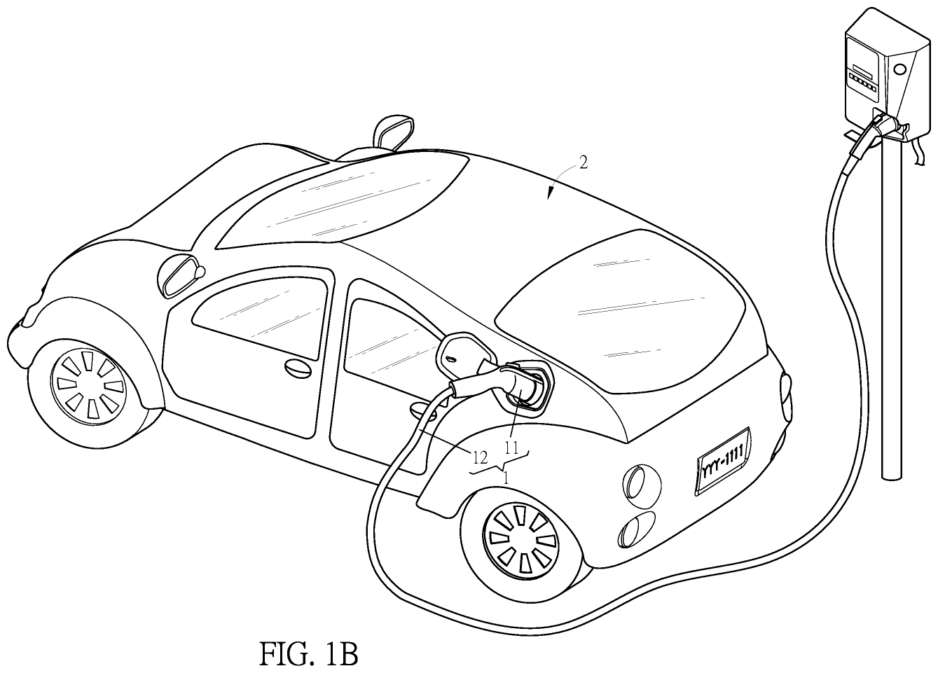

### DETAILED DESCRIPTION

A charging gun for charging an electric vehicle according to embodiments of the present invention is described below with reference to the relevant diagrams. The same elements are described with the same reference numerals.

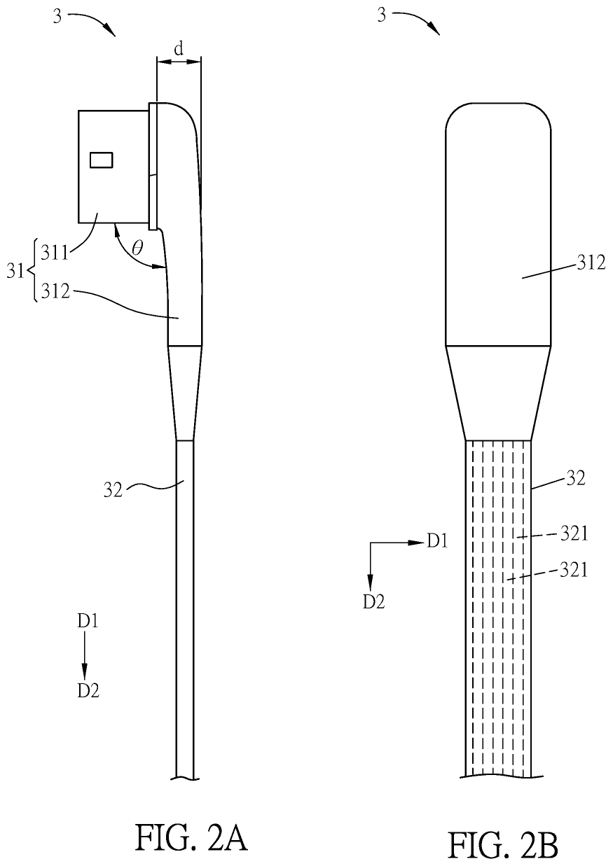

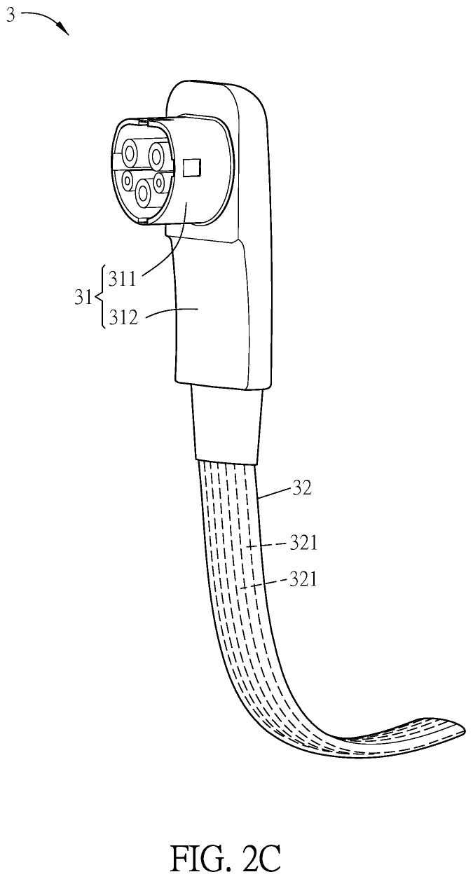

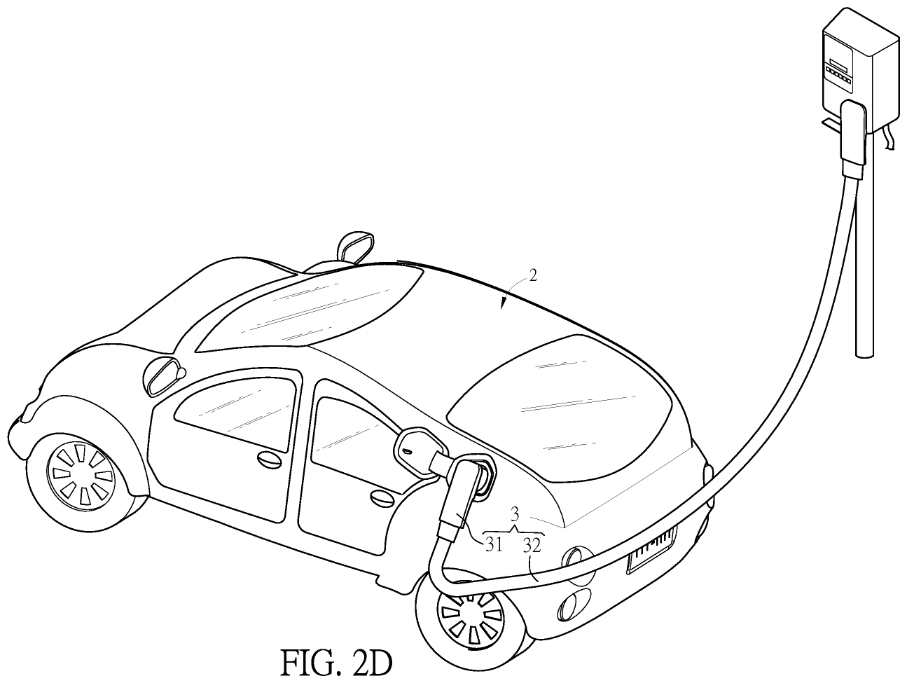

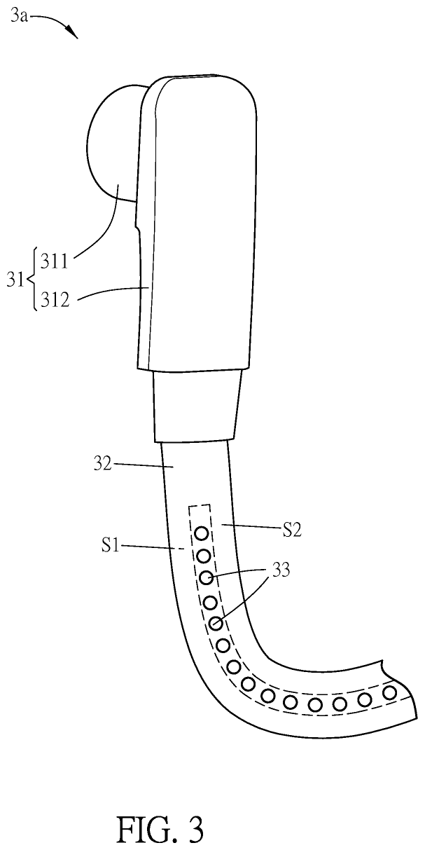

FIG. 2A to FIG. 2C are schematic diagrams of a charging gun according to an embodiment of the present invention at different perspectives, and FIG. 2D is a schematic diagram of the charging gun in FIG. 2C charging an electric vehicle.

As shown in FIG. 2A to FIG. 2D, a charging gun 3 of the present invention may include a charging connector 31 and a charging cable 32.

The charging connector 31 has an insertion portion 311 and a turning portion 312 connected to the insertion portion 311. As the name implies, when an electric vehicle 2 is to be charged, the insertion portion 311 is a plug, which is configured to be connected to (inserted into) a corresponding charging hole on a vehicle body. An included angle θ between the insertion portion 311 and the turning portion 312 is greater than or equal to 90 degrees and less than or equal to 100 degrees. In some embodiments, the insertion portion 311 may be substantially perpendicular to the turning portion 312, that is, the included angle θ may be, for example, 90 degrees, or may be slightly greater than 90 degrees (for example, 91.5 degrees). A rear-view mirror of the electric vehicle 2 generally extends out from the vehicle body by about 20 centimeters. Referring to FIG. 2A, in the charging gun 3 in this embodiment, a thickness d of the turning portion 312 is, for example, 3 centimeters. Therefore, when the charging gun 3 is inserted into the electric vehicle 2 for charging, it can be ensured that the charging gun 3 falls in the range by which the rear-view mirror extends out from the vehicle body, and it can be ensured that a distance between the charging gun 3 and the vehicle body is less than the distance by which the rear-view mirror extends out from the vehicle body.

The charging cable 32 is connected to the turning portion 312 of the charging connector 31. The charging cable 32 includes a plurality of wires 321 arranged in parallel in one direction D1, as shown in FIG. 2B. The direction D1 is substantially perpendicular to an extending direction D2 of the wires 321, and the wires 321 in this embodiment are flat wires. Since the charging cable 32 includes the plurality of flat wires 321, a thickness of the charging cable 32 can be quite small. In some embodiments, if the existing SAE J1772 charging connector is used as an example, a number of wires 321 may be 5 (corresponding to 5 plugs of the charging connector 31), and if the GB 20234.2 or IEC 62196-2 charging connector is used as an example, a number of wires 321 may be 7. In this embodiment, the charging connector 31 is, for example, the SAE J1772, but is not limited to the SAE J1772.

Based on the above, in the charging gun 3 in this embodiment, the included angle θ between the insertion portion 311 and the turning portion 312 of the charging connector 31 is greater than or equal to 90 degrees and less than or equal to 100 degrees, and the charging cable 32 includes the plurality of wires 321 arranged in parallel in the direction D1. As shown in FIG. 2D, when the charging gun 3 is used to charge the electric vehicle 2, even if a charging hole is on a left side of the vehicle body, a gap between the charging cable 32 and the vehicle body can be very small, which can avoid an excessively large gap between the charging gun and the vehicle body caused by the appearance design of the existing charging gun, and can avoid the problem that the charging cable hangs down onto the road and causes danger to passersby.

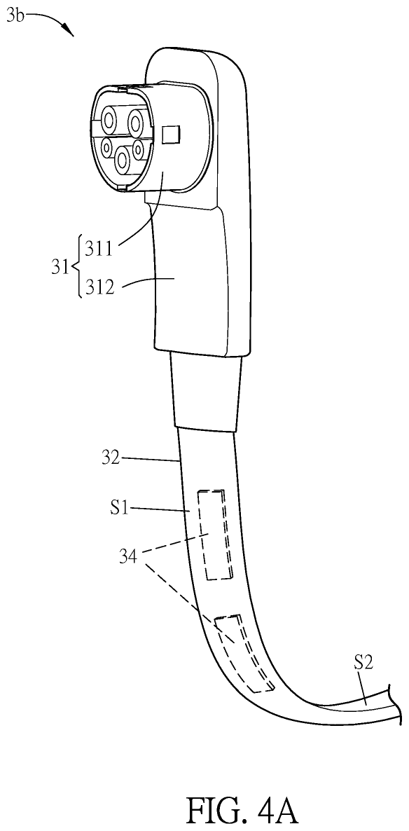

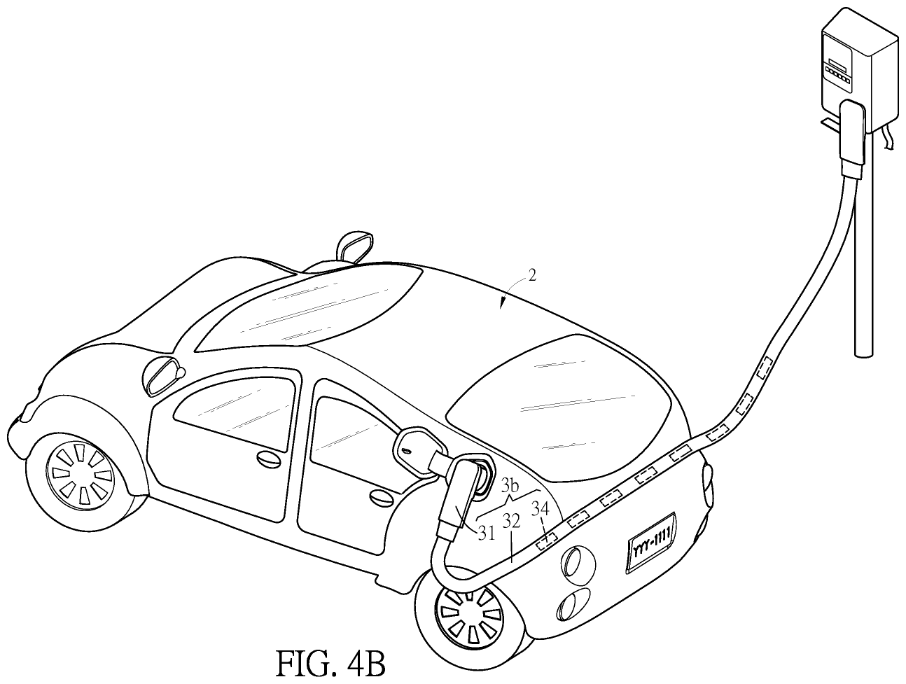

FIG. 3 and FIG. 4A are schematic diagrams of charging guns according to different embodiments of the present invention, and FIG. 4B is a schematic diagram of the charging gun in FIG. 4A charging an electric vehicle.

As shown in FIG. 3, an element composition and a connection relationship between elements of a charging gun 3a in this embodiment are substantially the same as those of the charging gun 3 in the previous embodiment, except that the charging gun 3a in this embodiment further includes at least one light-emitting element 33. The light-emitting element 33 is arranged on at least a side surface of the charging cable 32. The light-emitting element 33 is, for example, but not limited to a light-emitting diode (LED), and a plurality of light-emitting elements may be arranged. The light-emitting element is arranged at a position other than a side surface S1 of the charging cable 32 facing a body of the electric vehicle 2, to remind pedestrians to avoid hooking the charging cable 32 when passing by. In the charging gun 3a in this embodiment, the plurality of light-emitting elements 33 are mounted to another side surface S2 of the charging cable 32 facing away from the side surface S1, but the present invention is not limited thereto. In a different embodiment, the light-emitting elements 33 may be arranged on any of the other three sides of the charging cable 32 other than the side surface S1 facing the vehicle body, or the light-emitting elements 33 may be arranged on each of the other three sides other than the side surface S1 facing the vehicle body, even the light-emitting elements 33 may be arranged on the side surface S1 of the charging cable line 32. This is not limited in the present invention.

In addition, as shown in FIG. 4A and FIG. 4B, an element composition and a connection relationship between elements of a charging gun 3b in this embodiment are substantially the same as those of the charging gun 3 in the previous embodiment, except that the charging gun 3b in this embodiment further includes at least one magnetic element 34. The magnetic element 34 may be magnet, and is arranged on the side surface S1 of the charging cable 32 facing the electric vehicle 2 when the charging connector 31 is inserted in the electric vehicle 2. In this embodiment, a plurality of magnetic elements 34 are arranged on the side surface S1 of the charging cable 32 facing the electric vehicle 2, for example. Therefore, when the charging gun 3b is used to charge the electric vehicle 2, regardless of whether the charging hole is on a left side, a right side, or a front of the vehicle body, by adsorbing the magnetic element 34 on the body of the electric vehicle 2, the charging cable 32 may be made closer to the vehicle body, and the problem that the charging cable 32 falls onto the ground and causes danger to passersby may be avoided.

In addition, it may be understood that in some embodiments, the charging gun may be provided with both the light-emitting element 33 and the magnetic element 34. This is not limited in the present invention.

In conclusion, the present invention designs a new charging gun, in which the included angle between the insertion portion and the turning portion of the charging connector is designed to be greater than or equal to 90 degrees and less than or equal to 100 degrees, and the charging wires are flattened, so that the problem that the charging cable easily hangs down onto the road and causes danger to passersby can be avoided.

In an embodiment, the light-emitting element may be arranged on the charging gun of the disclosure, to remind passersby that the charging cable is connected to the vehicle on the roadside for charging. In an embodiment, the magnetic element may be further arranged on the charging gun of the disclosure, so that the charging cable can be adsorbed on the vehicle body through the magnetic element, thereby making the charging cable closer to the vehicle body and avoiding the problem that the charging cable easily hangs down onto the road and causes danger to passersby.

The above descriptions are merely examples but not limitations. Any equivalent modification or change to the present invention without departing from the spirit and scope thereof are included in appended claims.

What is claimed is:

1. A charging gun for charging an electric vehicle, comprising:
a charging connector, having an insertion portion and a turning portion connected to the insertion portion, wherein an included angle between the insertion portion and the turning portion is greater than or equal to 90 degrees and less than or equal to 100 degrees; and
a charging cable, connected to the turning portion and comprising a plurality of wires arranged in parallel in one direction.

2. The charging gun according to claim 1, wherein the insertion portion is substantially perpendicular to the turning portion.

3. The charging gun according to claim 1, wherein the direction is substantially perpendicular to an extending direction of the wires.

4. The charging gun according to claim 1, further comprising:
at least one light-emitting element, arranged on at least a side surface of the charging cable.

5. The charging gun according to claim 4, wherein the light-emitting element is arranged at a position other than a side surface of the charging cable facing a body of the electric vehicle.

6. The charging gun according to claim 1, further comprising:
at least one magnetic element, arranged on a side surface of the charging cable facing the electric vehicle when the charging connector is inserted in the electric vehicle.

7. The charging gun according to claim 2, further comprising:
at least one magnetic element, arranged on a side surface of the charging cable facing the electric vehicle when the charging connector is inserted in the electric vehicle.

8. The charging gun according to claim 3, further comprising:
at least one magnetic element, arranged on a side surface of the charging cable facing the electric vehicle when the charging connector is inserted in the electric vehicle.

9. The charging gun according to claim 4, further comprising:
at least one magnetic element, arranged on a side surface of the charging cable facing the electric vehicle when the charging connector is inserted in the electric vehicle.

10. The charging gun according to claim 5, further comprising:
at least one magnetic element, arranged on a side surface of the charging cable facing the electric vehicle when the charging connector is inserted in the electric vehicle.
